(19) United States
(12) Patent Application Publication
(10) Pub. No.: US 2011/0076559 A1
(43) Pub. Date: Mar. 31, 2011

(54) POSITIVE ELECTRODE FOR NON-AQUEOUS ELECTROLYTE SECONDARY BATTERY AND NON-AQUEOUS ELECTROLYTE SECONDARY BATTERY

(75) Inventors: Tadayoshi Tanaka, Osaka (JP); Hiroshi Minami, Kobe-shi (JP); Naoki Imachi, Kobe-shi (JP)

(73) Assignee: SANYO ELECTRIC CO., LTD., Osaka (JP)

(21) Appl. No.: 12/893,505

(22) Filed: Sep. 29, 2010

(30) Foreign Application Priority Data
Sep. 29, 2009 (JP) 2009-224822

(51) Int. Cl. H01M 4/60

(52) U.S. Cl. 429/212

(57) ABSTRACT

A positive electrode for a non-aqueous electrolyte secondary battery, having an active material layer containing a positive electrode active material and an inorganic particle layer provided on a surface of the active material layer. The inorganic particle contains inorganic particles, a polyvinyl pyrrolidone, and an aqueous binder.

### BACKGROUND OF THE INVENTION

1. Field of the Invention

The present invention relates to a positive electrode used for non-aqueous electrolyte secondary batteries such as lithium-ion secondary batteries, and a non-aqueous electrolyte secondary battery using the positive electrode.

2. Description of Related Art

Rapid advancements in size and weight reductions of mobile information terminal devices such as mobile telephones, notebook computers, and PDAs in recent years have created demands for higher capacity batteries as driving power sources for such devices. The capacity of lithium-ion secondary batteries, which have high energy density among the secondary batteries, has increased year by year. However, as the capacity of the batteries increases, the safety and reliability thereof tend to lower. Consequently, development of the elemental technology for assuring the safety and reliability has been actively pursued.

In Japanese Patent No. 3371301 and Published PCT Application WO 2005/057691, it has been proposed to form a porous insulating layer on a surface of the positive electrode or the negative electrode to improve the reliability and safety. Apart from improvements in safety, it has been proposed in Japanese Published Unexamined Patent Application Nos. 2007-280917 and 2007-280918 to improve the high-temperature storage performance of a high voltage battery by forming an inorganic particle layer on a specific electrode surface.

In Japanese Published Unexamined Patent Application No. 2005-259467, it has been proposed to improve the electrolyte solution absorbency of the electrode by intentionally forming irregularities in a porous layer.

Although providing an inorganic particle layer on an electrode surface can improve the cycle performance, a problem is that the capacity is low at the early stage of charge-discharge cycles. The present inventors have investigated the causes of such low capacity at the early stage of cycles.

FIG. 1 shows a graph illustrating the relationship between number of cycles and capacity for a conventional battery using a positive electrode having an inorganic particle layer.

In FIG. 1, the graph line denoted as “INORGANIC PARTICLE LAYER PRESENT” represents the cycle performance of a conventional non-aqueous electrolyte secondary battery using a positive electrode that has an inorganic particle layer, whereas the graph line denoted as “INORGANIC PARTICLE LAYER ABSENT” represents the cycle performance of a non-aqueous electrolyte secondary battery using a positive electrode that does not have the inorganic particle layer. As seen from FIG. 1, the conventional battery denoted as “INORGANIC PARTICLE LAYER PRESENT”, which has an inorganic particle layer, shows better cycle performance than the one denoted as “INORGANIC PARTICLE LAYER ABSENT”. However, it shows lower capacity at the early stage of cycles. It is believed that such low capacity at the early stage of cycles occurs because the inorganic particle layer hinders the permeation of the non-aqueous electrolyte into the positive electrode is, impeding the charge-discharge reaction.

### BRIEF SUMMARY OF THE INVENTION

It is an object of the present invention to provide a positive electrode for a non-aqueous electrolyte secondary battery that has excellent permeability of non-aqueous electrolyte solution and is capable of enhancing charge-discharge characteristics, and a non-aqueous electrolyte secondary battery using the positive electrode.

The positive electrode for a non-aqueous electrolyte secondary battery according to the present invention comprises an active material layer containing a positive electrode active material, and an inorganic particle layer provided on a surface of the active material layer, the inorganic particle layer containing inorganic particles, a polyvinyl pyrrolidone, and an aqueous binder.

The method of manufacturing a positive electrode for a non-aqueous electrolyte secondary battery according to the present invention comprises the steps of: preparing an aqueous slurry containing inorganic particles, a polyvinyl pyrrolidone, and an aqueous binder; and applying the aqueous slurry on a surface of an active material layer to form an inorganic particle layer.

A non-aqueous electrolyte secondary battery according to the present invention comprises the positive electrode for a non-aqueous electrolyte secondary battery according to the present invention, a negative electrode, and a non-aqueous electrolyte solution.

The present invention makes available a positive electrode for a non-aqueous electrolyte secondary battery that has excellent permeability of a non-aqueous electrolyte solution and is capable of enhancing charge-discharge characteristics.

The method of manufacturing a positive electrode for a non-aqueous electrolyte secondary battery according to the present invention makes it possible to manufacture the positive electrode for a non-aqueous electrolyte secondary battery that has excellent permeability of the non-aqueous electrolyte solution and is capable of enhance the charge-discharge characteristics efficiently.

The non-aqueous electrolyte secondary battery according to the present invention has excellent permeability of the non-aqueous electrolyte solution in the positive electrode because it uses the above-described inventive positive electrode for a non-aqueous electrolyte secondary battery. As a result, it can prevent the degradation of the capacity at the early stage of cycles and enhance the charge-discharge characteristics.

### BRIEF DESCRIPTION OF THE DRAWING

FIG. 1 is a graph illustrating the cycle performance (capacity versus number of cycles) of a conventional non-aqueous electrolyte secondary battery that has an inorganic particle layer and a conventional non-aqueous electrolyte secondary battery that does not have an inorganic particle layer.

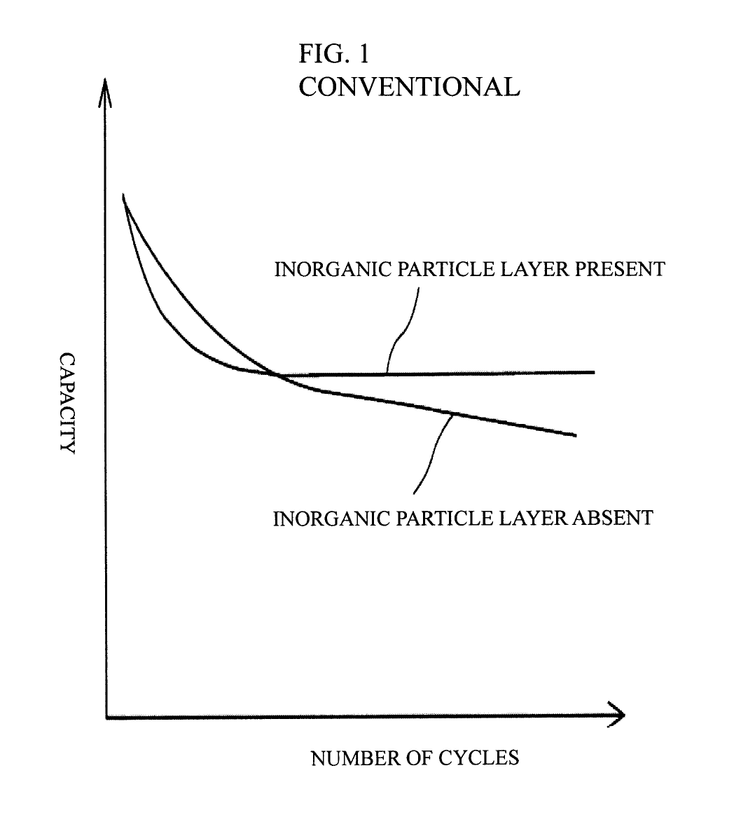

### DETAILED DESCRIPTION OF THE INVENTION

The positive electrode for a non-aqueous electrolyte secondary battery according to the present invention comprises an active material layer containing a positive electrode active material, and an inorganic particle layer provided on a surface of the active material layer. The inorganic particle layer contains inorganic particles, a polyvinyl pyrrolidone, and an aqueous binder.

According to the present invention, a polyvinyl pyrrolidone is contained in the inorganic particle layer. As a result, the affinity of the inorganic particle layer to the non-aqueous electrolyte solution can be increased, and the permeability of the non-aqueous electrolyte solution to the inorganic particle layer can be increased. Accordingly, the permeability of the non-aqueous electrolyte solution to the positive electrode can also be increased. Therefore, the capacity deterioration at the early stage of cycles can be minimized, and the charge-discharge characteristics can be enhanced.

In the present invention, it is preferable that the content of the polyvinyl pyrrolidone in the inorganic particle layer be within the range of from 0.01 parts by mass to 1 part by mass, more preferably from 0.05 parts by mass to 0.5 parts by mass, with respect to 100 parts by mass of the inorganic particles. If the content of the polyvinyl pyrrolidone is too low, the affinity between the inorganic particle layer and the non-aqueous electrolyte solution cannot be obtained sufficiently, resulting in insufficient permeability. Consequently, an electrode having good charge-discharge characteristics may not be obtained. In addition, if the content of the polyvinyl pyrrolidone is too low, the dispersion capability of the aqueous slurry for forming the inorganic particle layer may become too low, because polyvinyl pyrrolidone also serves as a dispersing agent of the slurry for forming the inorganic particle layer.

On the other hand, if the content of the polyvinyl pyrrolidone in the inorganic particle layer is too high, the effect of improving the non-aqueous electrolyte solution permeability saturates, and the polyvinyl pyrrolidone may hinder lithium ion conduction. Consequently, the charge-discharge characteristics may degrade.

In the present invention, the inorganic particle layer may further contain at least one of CMC (carboxymethylcellulose) and a polyacrylic acid salt. Adding at least one of these substances improves the dispersion capability of the aqueous slurry for forming the inorganic particle layer.

The cation for forming the polyacrylic acid salt is not particularly limited. Examples include inorganic cations of alkali metals such as sodium and potassium, inorganic cations of alkaline-earth metals such as calcium and magnesium, and organic cations of quaternary amines. Particularly preferable is cation of sodium, which does not adversely affect battery characteristics.

It is preferable that the content of the CMC and the polyacrylic acid salt in the inorganic particle layer be within the range of from 0.01 parts by mass to 0.50 parts by mass, more preferably from 0.05 parts by mass to 0.20 parts by mass, with respect to 100 parts by mass of the inorganic particles.

In the present invention, examples of the substances usable for the inorganic particles used for forming the inorganic particle layer include rutile-type titanium oxide (rutile-type titania), aluminum oxide (alumina), zirconium oxide (zirconia) and magnesium oxide (magnesia). It is preferable that the average particle size of the inorganic particles be 1 nm or less, more preferably in the range of from 0.1 nm to 0.8 nm. Taking into consideration the stability in the battery (i.e., the reactivity with lithium) and costs, aluminum oxide and rutile-type titanium oxide are particularly preferable.

In the present invention, it is preferable that the thickness of the inorganic particle layer be 4 nm or less, more preferably within the range of from 0.5 nm to 4 nm, and still more preferably within the range of from 0.5 nm to 2 nm. If the thickness of the inorganic particle layer is too thin, the effect of improving the reliability and safety, obtained by forming the inorganic particle layer, may be insufficient. On the other hand, if the thickness of the inorganic particle layer is too thick, the rate performance and the energy density of the battery may be degraded.

In the present invention, the aqueous binder used as the binder of the inorganic particle layer is not particularly limited as long as it is a binder used for an aqueous solvent. Examples include those in the form of emulsion resins and water-soluble resins. Particularly preferable is one that comprehensively satisfies the following characteristics: (1) dispersion capability of inorganic particles (for preventing re-aggregation), (2) ensuring adhesion that can withstand through the manufacturing process of the battery, (3) filling the gaps between the inorganic particles resulting from the expansion after absorbing the non-aqueous electrolyte, and (4) causing less dissolution of the non-aqueous electrolyte. In order to ensure sufficient battery performance, it is preferable that these effects can be obtained with a small amount of the binder. For this reason, it is preferable that the content of the aqueous binder in the inorganic particle layer be 30 parts by mass or less, more preferably 10 parts by mass or less, and still more preferably 5 parts by mass, with respect to 100 parts by mass of the inorganic particles. The lower limit value of the content of the aqueous binder in the inorganic particle layer is generally 0.1 parts by mass or greater.

Examples of the aqueous binder include polytetrafluoroethylene (PTFE), polyacrylonitrile (PAN), styrene-butadiene rubber (SBR), modified substances thereof, derivatives thereof, emulsion resins such as copolymers containing acrylonitrile units, and polyacrylic acid derivatives. A copolymer containing acrylonitrile units is preferable especially when it is considered important to obtain the above-listed characteristics (1) to (3) with a small amount of the aqueous binder.

The method, according to the present invention, of manufacturing a positive electrode for a non-aqueous electrolyte secondary battery can manufacture the foregoing inventive positive electrode for a non-aqueous electrolyte secondary battery. The method comprises the steps of: preparing an aqueous slurry containing inorganic particles, a polyvinyl pyrrolidone, and an aqueous binder; and applying the aqueous slurry on a surface of an active material layer to form an inorganic particle layer.

The manufacturing method according to the present invention makes it possible to manufacture the above-described inventive positive electrode for a non-aqueous electrolyte secondary battery efficiently.

The aqueous slurry can be prepared by mixing inorganic particles, a polyvinyl pyrrolidone, an aqueous binder, and an aqueous solvent together. Generally, it is preferable to use water as the aqueous solvent. A water-soluble additive agent may be added thereto as needed. As mentioned above, polyvinyl pyrrolidone also serves as a dispersing agent in the aqueous slurry. Additionally, another dispersing agent or the like may be added as necessary.

The inorganic particles in the aqueous slurry may be dispersed by a wet dispersion method using, for example, a bead mill and a dispersion machine that disperse particles while applying a shearing stress such as a FILMICS mixer made by Primix Corp. In particular, it is preferable to perform a mechanical dispersion treatment since it is preferable that the inorganic particles used in the present invention have a small average particle size. A dispersion technique used for the dispersion of paint may be used preferably as the dispersion method.

Examples of the method for forming the inorganic particle layer by applying the aqueous slurry onto the surface of the active material layer positive electrode surface include die coating, gravure coating, dip coating, curtain coating, and spray coating. Gravure coating and die coating are especially preferable. Taking into consideration the degradation of bonding strength resulting from the diffusion of the solvent or the binder into the electrode, it is preferable to use a method that can perform the coating at a high speed and require a short drying time.

The concentration of the solid content in the slurry varies depending on the method of coating. For the spray coating, dip coating, and curtain coating, in which the thickness of coating is difficult to control mechanically, it is preferable that the concentration of the solid content be low, within the range of from 3 mass % to 30 mass %. On the other hand, for die coating, gravure coating, and the like, the concentration of the solid content may be high, and it may preferably be about 5 mass % to 70 mass %.

The inorganic particle layer can be formed on the surface of the active material layer applying the aqueous slurry onto the surface of the active material layer and thereafter drying it.

When the inorganic particle layer contains further contains at least one of CMC and a polyacrylic acid salt as described above, the aqueous slurry further contains at least one of CMC and a polyacrylic acid salt.

In the present invention, the non-aqueous electrolyte secondary battery comprises the foregoing inventive positive electrode for a non-aqueous electrolyte secondary battery, a negative electrode, and a non-aqueous electrolyte solution.

As described above, the positive electrode of the present invention has the inorganic particle layer on a surface of the active material layer containing the positive electrode active material. The positive electrode active material is not particularly restricted as long as it is capable of intercalating and deintercalating lithium and its potential is noble. Usable examples include lithium-transition metal composite oxides having a layered structure, a spinel structure, and an olivine structure. In particular, the lithium-transition metal composite oxide having a layered structure is preferable from the viewpoint of achieving high energy density. Examples of the lithium-transition metal composite oxides include lithium-nickel composite oxides, lithium-nickel-cobalt composite oxides, lithium-nickel-cobalt-aluminum composite oxides, lithium-nickel-cobalt-manganese composite oxides, and lithium-cobalt composite oxides.

The negative electrode used in the present invention contains a negative electrode active material.

The negative electrode active material used in the present invention is not particularly limited as long as it is usable as a negative electrode active material in a non-aqueous electrolyte secondary battery. Examples of the negative electrode active material include carbon materials such as graphite and coke, metals capable of alloying with lithium such as tin oxide, metallic lithium, and silicon, and alloys thereof.

The non-aqueous electrolyte solution used in the present invention is not particularly limited as long as it is usable for a non-aqueous electrolyte secondary battery. Generally, examples include those containing a supporting salt and a solvent.

Examples of the supporting salt include LiBF₄, LiPF₆, LiN(SO₂CF₃)₂, LiN(SO₂C₂F₅)₂, and LiPF₆₋ₓ(CₙF₂ₙ₊₁)ₓ (where 1<x<6 and n=1 or 2). These may be used either alone or in combination of two or more of them. The concentration of the supporting salt is not particularly limited, but is preferably within the range of from 0.8 to 1.8 mol/liter.

Preferable examples of the solvent include carbonate solvents such as ethylene carbonate, propylene carbonate, γ-butyrolactone, diethylene carbonate, ethyl methyl carbonate, and dimethyl carbonate, and carbonate solvents in which part of hydrogen is substituted by F in the foregoing solvents. It is preferable to use a combination of a cyclic carbonate and a chain carbonate as the solvent.

### EXAMPLES

Hereinbelow, the present invention is described in further detail. It should be construed, however, that the present invention is not limited to the following examples but various changes and modifications are possible without departing from the scope of the invention.

### Preparation of Positive Electrode

### Example 1

### Formation of Active Material Layer in Positive Electrode

Lithium cobalt oxide, acetylene black as a carbon conductive agent, and PVDF (polyvinylidene fluoride) were mixed at a mass ratio of 95:2.5:2.5, then N-methyl-2-pyrrolidone (NMP) was as added thereto as a solvent, and the mixture was mixed with a mixer, to prepare a mixture slurry. The prepared slurry was applied onto both sides of an aluminum foil, and the resultant material was then dried and calendered, whereby an active material layer was formed the aluminum foil serving as a current collector. The filling density of the active material layer was 3.60 g/cm³.

### Formation of Inorganic Particle Layer

Water was used as the solvent, and titanium oxide (TiO₂, average particle size: 0.25 μm, with no surface treatment layer, made by Ishihara Sangyo Co., Ltd., under the trade name of CR-EL) was used as the inorganic particles. An emulsion resin of styrene-butadiene rubber (SBR) was used as the aqueous binder. PITZCOL K-90 (trade name, made by Dai-ichi Kogyo Seiyaku Corp.) was used as the polyvinyl pyrrolidone.

The concentration of the solid content of the inorganic particles was set at 40 mass %. The aqueous binder was used in an amount of 3 parts by mass with respect to 100 parts by mass of the inorganic particles. The polyvinyl pyrrolidone (PVP) was used in an amount of 0.2 parts by mass with respect to 100 parts by mass of the inorganic particles. Thus, an aqueous slurry was prepared.

The resultant aqueous slurry was coated onto the active material layer formed in the above-described manner by gravure coating. Then, water, which is the solvent, was removed by drying, to form inorganic particle layers on the respective active material layers on both sides of the current collector.

The thickness of each of the inorganic particle layers was 2 μm, so the total thickness of the inorganic particle layers on both sides was 4 μm. The positive electrode was prepared in the foregoing manner. The positive electrode thus prepared is referred to as T1.

### Example 2

A positive electrode was prepared in the same manner as described in Example 1, except that the amount of the PVP was 0.05 parts by mass with respect to 100 parts by mass of the inorganic particles. The positive electrode thus prepared is referred to as T2.

### Example 3

A positive electrode was prepared in the same manner as described in Example 1, except that the amount of the PVP was 0.1 parts by mass with respect to 100 parts by mass of the inorganic particles. The positive electrode thus prepared is referred to as T3.

### Example 4

A positive electrode was prepared in the same manner as described in Example 1, except that the amount of the PVP was 0.5 parts by mass with respect to 100 parts by mass of the inorganic particles. The positive electrode thus prepared is referred to as T4.

### Example 5

A positive electrode was prepared in the same manner as described in Example 1, except that the amount of the PVP was 0.1 parts by mass with respect to 100 parts by mass of the inorganic particles, and in addition, 0.1 parts by mass of carboxymethylcellulose (made by Daicel Chemical Industries, Ltd., item number “1380”) with respect to 100 parts by mass of the inorganic particles was used. The positive electrode thus prepared is referred to as T5.

### Example 6

A positive electrode was prepared in the same manner as described in Example 1, except that the amount of the PVP was 0.1 parts by mass with respect to 100 parts by mass of the inorganic particles, and in addition, 0.1 parts by mass of sodium polyacrylate (degree of polymerization: 22,000 to 66,000) with respect to 100 parts by mass of the inorganic particles was used. The positive electrode thus prepared is referred to as T6.

### Comparative Example 1

A positive electrode was prepared in the same manner as described in Example 1, except that that no inorganic particle layer was provided on the active material layers. The positive electrode thus prepared is referred to as R1.

### Comparative Example 2

A slurry was prepared in the same manner as described in Example 1, except that PVP was not contained in the inorganic particle layers. However, the dispersion capability of the inorganic particles in the slurry turned out to be so poor that uniform inorganic particle layers could not be formed on the active material layers. For this reason, the tests were not carried out thereafter. The positive electrode thus prepared is referred to as R2.

### Comparative Example 3

A positive electrode was prepared in the same manner as described in Example 1, except that the inorganic particle layers were formed using carboxymethylcellulose as the dispersing agent in place of PVP. The positive electrode thus prepared is referred to as R3.

### Comparative Example 4

A positive electrode was prepared in the same manner as described in Example 1, except that the inorganic particle layers were formed using sodium polyacrylate as the dispersing agent in place of PVP. The positive electrode thus prepared is referred to as R4.

### Evaluation of Slurry Dispersion Capability

The dispersion capability of the inorganic particles in the aqueous slurry for forming the inorganic particle layer was evaluated using the following criteria.

Very good: No precipitation or aggregation of the inorganic particles was observed 2 days after the preparation of the slurry.

Good: No precipitation or aggregation of the inorganic particles was observed 1 day after the preparation of the slurry.

Fair: No precipitation or aggregation of the inorganic particles was observed 1 hour after the preparation of the slurry.

Poor: Precipitation and aggregation of the inorganic particles were observed within 1 hour after the preparation of the slurry.

The results of the evaluation are shown in Table 1 below.

### Evaluation of Non-Aqueous Electrolyte Permeability of Positive Electrode

For each of the positive electrodes, 3 μL of propylene carbonate was dropped onto the inorganic particle layer of the positive electrode, and the time it takes for the droplets on the inorganic particle layer to disappear was measured and determined as the permeation time. The results of the measurement are shown in Table 1 below.

### Preparation of Lithium Secondary Battery

### Preparation of Negative Electrode

A carbon material (graphite) was used as the negative electrode active material. Using CMC (carboxymethylcellulose sodium) and SBR (styrene-butadiene rubber), these were mixed so that the mass ratio of the negative electrode, CMC, and SBR became 98:1:1, to prepare a slurry for forming a negative electrode mixture layer.

The resulting slurry for forming a negative electrode mixture layer was applied onto both sides of a copper foil, then dried, and calendered, to form a negative electrode.

The filling density of the negative electrode active material was set at 1.60 g/cm³.

### Preparation of Non-Aqueous Electrolyte Solution

LiPF₆ was dissolved at a concentration of 1 mole/liter into a mixed solvent of 3:7 volume ratio of ethylene carbonate (EC) and diethyl carbonate (DEC), to prepare a non-aqueous electrolyte solution.

### Construction of Battery

Lead terminals were attached to the positive electrode and the negative electrode prepared in the above-described manner, and they were spirally wound with separators interposed therebetween. These were pressed into a flat shape to prepare an electrode assembly. The electrode assembly was inserted into an aluminum laminate serving as a battery case. Thereafter, the foregoing non-aqueous electrolyte was filled therein, the battery case was sealed, and the resultant article was sandwiched and fixed by a clamp. Thus, a test battery was prepared. The design capacity of the test battery was set at 850 mAh.

The battery was designed so that the end-of-charge voltage became 4.4 V, and it was also designed so that the capacity ratio of the positive electrode and the negative electrode (the initial charge capacity of the negative electrode/the initial charge capacity of the positive electrode) became 1.08.

The separator used was a microporous polyethylene film having an average pore size of 0.1 nm, a film thickness of 16 nm, and a porosity of 47%.

Lithium secondary batteries were fabricated using the positive electrodes T1 to T6 according to the present invention and the comparative positive electrodes R1, R3, and R4 as the positive electrodes, and the following charge-discharge cycle test was conducted for the fabricated lithium secondary batteries.

### Charge-Discharge Cycle Test

Each of the batteries was charged at a constant current of 1 It (850 mA) until the battery voltage reached 4.4 V, and thereafter charged at a constant voltage of 4.4 V to a current of 0.05 It (42.5 mA). Each battery was rested for 10 minutes and thereafter discharged at a constant current of 1 It (850 mA) until the battery voltage reached 2.75 V. Then, the discharge capacity for each battery was measured, and each battery was rested for 10 minutes. The just-described charge-discharge cycle was repeated, and the capacity after the 50th cycle and the capacity after the 300th cycle were determined as the discharge capacity in the early cycle life and the discharge capacity in the later cycle life, respectively.

The discharge capacity in the early cycle life and the discharge capacity in the later cycle life were evaluated for each of the batteries. The results of the evaluation are show in Table 1 below. In Table 1, the ones that showed lower discharge capacities in the early cycle life than the discharge capacity in the early cycle life of the battery that used the comparative positive electrode R1 are denoted as “Poor”, and the ones that showed higher discharge capacities in the early cycle life than that are denoted as “Good”. As for the discharge capacity in the later cycle life, the ones that showed higher discharge capacities in the later cycle life than that of the battery using the comparative positive electrode R1 are denoted as “Good”, and the ones that showed lower discharge capacities in the later cycle life than that are denoted as “Poor”.

TABLE 1

| | | Slurry | | Discharge | Discharge |
|---|---|---|---|---|---|
| Positive | | dispersion | Permeation | capacity in the | capacity in the |
| electrode | Inorganic particle layer | capability | time | early cycle life | later cycle life |
| T1 | Inorganic particle + | Good | 18 min. 36 sec. | Good | Good |
| | PVP 0.2 + | | | | |
| | Aqueous binder | | | | |
| T2 | Inorganic particle + | Fair | 20 min. 40 sec. | Good | Good |
| | PVP 0.05 + | | | | |
| | Aqueous binder | | | | |
| T3 | Inorganic particle + | Good | 19 min. 45 sec. | Good | Good |
| | PVP 0.1 + | | | | |
| | Aqueous binder | | | | |
| T4 | Inorganic particle + | Very good | 18 min. 31 sec. | Good | Good |
| | PVP 0.5 + | | | | |
| | Aqueous binder | | | | |
| T5 | Inorganic particle + | Very good | 21 min. 50 sec. | Good | Good |
| | CMC 0.1 + PVP 0.1 + | | | | |
| | Aqueous binder | | | | |
| T6 | Inorganic particle + | Very good | 21 min. 51 sec. | Good | Good |
| | Na polyacrylate 0.1 + | | | | |
| | PVP 0.1 + | | | | |
| | Aqueous binder | | | | |
| R1 | N/A | — | 20 min. 50 sec. | Good | Poor |
| R2 | Inorganic particle + | Poor | — | — | — |
| | Aqueous binder | | | | |
| R3 | Inorganic particle + | Very good | 24 min. 10 sec. | Poor | Good |
| | CMC 0.2 + | | | | |
| | Aqueous binder | | | | |
| R4 | Inorganic particle + | Very good | 23 min. 26 sec. | Poor | Good |
| | Na polyacrylate 0.2 + | | | | |
| | Aqueous binder | | | | |

As clearly seen from the results shown in Table 1, the positive electrodes T1 to T6, in which the inorganic particle layers containing PVP were formed according to the present invention, showed shorter permeation time than the positive electrodes R3 and R4, in which the inorganic particle layers not containing PVP were formed. As for the discharge capacity in the early cycle life, the barriers using the positive electrodes T1 to T6 according to the present invention exhibited higher discharge capacities in the early cycle life than those using the comparative positive electrodes R3 and R4. This demonstrates that by allowing the inorganic particle layer to contain PVP according to the present invention, the permeability of the non-aqueous electrolyte solution is improved, and the capacity loss at the early stage of cycles is minimized.

As for the discharge capacity in the later cycle life, the batteries using the positive electrodes T1 to T6 according to the present invention exhibited higher discharge capacities in the later cycle life than the comparative positive electrode R1, which had no inorganic particle layer, because the batteries using the positive electrodes T1 to T6 are provided with inorganic particle layers and therefore achieved improved cycle performance due to the filtering effect of the inorganic particle layers and the like.

As for the slurry dispersion capability, it is demonstrated from the comparison between the positive electrodes T1 and T3 and the positive electrodes T5 and T6 that the slurry dispersion capability is improved by allowing the inorganic particle layer to contain CMC or a polyacrylic acid salt.

When CMC or a polyacrylic acid salt is not contained in the inorganic particles, it is necessary that 0.5 parts by mass of PVP be contained in the inorganic particles in order to obtain good slurry dispersion capability. On the other hand, when CMC or a polyacrylic acid salt is contained in the inorganic particles, good slurry dispersion capability can be obtained even if the total amount of the PVP and CMC, or PVP and a polyacrylic acid salt is less than 0.5 parts by mass. Here, if the content of the PVP, CMC, and polyacrylic acid salt contained in the inorganic particle layer is too high, the effect of improving the non-aqueous electrolyte solution permeability saturates, and the PVP and so forth may hinder lithium ion conduction, and consequently, the charge-discharge characteristics may degrade. For this reason, it is preferable that the inorganic particle layer is allowed to contain CMC or a polyacrylic acid salt.

As described above, the present invention makes it possible to increase the permeability of the non-aqueous electrolyte solution in the positive electrode in which an inorganic particle layer is provided, and to improve the charge-discharge characteristics. Such permeability of the non-aqueous electrolyte solution is affected especially in a battery in which a construction pressure is applied to the electrodes. Therefore, the advantageous effects of the present invention are exhibited particularly noticeably in cylindrical batteries and prismatic batteries.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A positive electrode for a non-aqueous electrolyte secondary battery, comprising: an active material layer containing a positive electrode active material; and an inorganic particle layer provided on a surface of the active material layer, the inorganic particle layer containing inorganic particles, a polyvinyl pyrrolidone, and an aqueous binder.

2. The non-aqueous electrolyte secondary battery according to claim 1, wherein the inorganic particle layer further contains at least one of carboxymethylcellulose and a polyacrylic acid salt.

3. The positive electrode for a non-aqueous electrolyte secondary battery according to claim 1, wherein the content of the polyvinyl pyrrolidone in the inorganic particle layer is within the range of from 0.01 parts by mass to 1 part by mass, with respect to 100 parts by mass of the inorganic particles.

4. A non-aqueous electrolyte secondary battery comprising a positive electrode according to claim 1, a negative electrode, and a non-aqueous electrolyte.

5. A non-aqueous electrolyte secondary battery comprising a positive electrode according to claim 2, a negative electrode, and a non-aqueous electrolyte.

6. A non-aqueous electrolyte secondary battery comprising a positive electrode according to claim 3, a negative electrode, and a non-aqueous electrolyte.
